(19) United States
(12) Patent Application Publication
(10) Pub. No.: US 2018/0175694 A1
(43) Pub. Date: Jun. 21, 2018

(54) Electric Motor And Stator Thereof

(71) Applicant: JOHNSON ELECTRIC S.A., Murten (CH)

(72) Inventors: Ronny Keil, Shenzhen (CN); Daisuke Tsunashima, SHENZHEN (CN); Kwong Yip Poon, Hong Kong (CN); Yongqiang Song, Shenzhen (CN)

(21) Appl. No.: 15/819,244

(22) Filed: Nov. 21, 2017

(30) Foreign Application Priority Data
Dec. 16, 2016 (CN) 2016 1116 9354.4

(51) Int. Cl. H02K 3/50; H02K 3/28; H02K 5/22

(52) U.S. Cl. CPC H02K 3/50; H02K 5/225; H02K 3/28

(57) ABSTRACT

A stator includes a stator core and three phase windings wound on the stator core. The stator provides a neutral point terminal, each of the three phase windings comprises a phase connecting end and a neutral point connecting end, the neutral point connecting end of each of the three phase windings is fixed to and electrically connected to the neutral point terminal. The neutral point connecting ends of the three phase windings are electrically connected together at outside of the circuit board. The circuit board does not need to provide extra space or wiring layer to achieve the combination of the neutral point connecting ends of the three phase windings.

### CROSS REFERENCE TO RELATED APPLICATIONS

This non-provisional patent application claims priority under 35 U.S.C. § 119(a) from Patent Application No. 201611169354.4 filed in The People's Republic of China on Dec. 16, 2016.

### FIELD OF THE INVENTION

The present invention relates to the field of electric motors, and in particular to a winding connection structure of a three-phase brushless direct circuit motor.

### BACKGROUND OF THE INVENTION

Three-phase brushless direct circuit (BLDC) motors without mechanical brushes and commutators have advantages of small volume and simple control and therefore have been more and more applied to various kinds of equipments, such as household appliances, medical equipments, vehicles and power tools. In a traditional three-phase BLDC motor where the three phase windings are connected in star configuration, three phase windings should be connected to a neutral point, and a circuit board of the motor need to provide six terminals for connecting with the phase connecting ends and the neutral point connecting ends of the three phase windings. The neutral point connecting ends of all phase windings are electrically connected together at the circuit board, which requires the circuit board provide an extra space or additional wiring layer to electrically connect the neutral point connecting ends, which increases the cost of the circuit board and also results in noise generated by the circuits.

### SUMMARY OF THE INVENTION

Thus, there is a desire for an improved electric motor and stator with low noise and low cost.

A stator comprises a stator core and three phase windings wound on the stator core, the stator further comprises a neutral point terminal, each of the three phase windings comprises a phase connecting end and a neutral point connecting end, the neutral point connecting end of each of the three phase windings is fixed to the neutral point terminal.

Preferably, the stator further comprises a circuit board, the neutral point terminal and the neutral point connecting ends are spaced from the circuit board to define an electrical gap.

Preferably, the circuit board defines a through hole, the neutral point terminal and the neutral point connecting ends fixed to the neutral point terminal extend through the through hole and are spaced from a side wall of the circuit board bounding the through hole.

Preferably, the through hole has no pad.

Preferably, the stator further comprises three phase terminals, the phase connecting ends of the three phase windings are respectively connected to the phase terminals, the circuit board comprises three pad holes corresponding to the three phase terminals, and the three phase terminals are respectively welded to the pad holes.

Preferably, an area of the through hole is greater than that of the pad hole.

Preferably, the circuit board provides a pad corresponding to each pad hole, the pad being electrically connected to the corresponding pad hole via a wiring on the circuit board.

Preferably, the neutral point terminal is a post made of electrically conductive material.

Preferably, each neutral point connecting end is wound around the post with several turns.

Preferably, each neutral point connecting end is fixed to the post via welding or soldering.

Preferably, the stator further comprises an insulating bracket mounted on the stator core, the neutral point terminal is arranged on the insulating bracket.

Preferably, the stator comprises a housing with an open end and an end cap mounted to the open end, the stator core is mounted in the housing with the neutral point terminal facing the end cap, a wire outlet is defined in the end cap.

The present disclosure further provides an electric motor comprising a stator described above and a rotor rotatable relative to the stator.

In the present embodiments, the stator of the motor is provided with the neutral point terminal where the neutral point connecting ends of the three phase windings are electrically connected together. Thus, there is no need to connect the neutral point connecting ends through the circuit board, and the circuit board does not need to provide extra space or wiring layer to achieve the electrical combination/connection between the neutral point connecting ends of the three phase windings, which reduces the cost of the circuit board, simplifies the production process of the circuit board.

### BRIEF DESCRIPTION OF THE DRAWINGS

FIG. 1 is a perspecitve view of an electric motor according to an embodiment of the present disclosure.

FIG. 2 is an exploded view of the electric motor of FIG. 1.

FIG. 3 is a perspecitve view of a stator of FIG. 2.

FIG. 4 is a perspecitve view of a circuit board of FIG. 2.

FIG. 5 is a perspecitve view of the electric motor of FIG. 1 with a housing, an end cap, an insulating ring and a rotor removed.

### DETAILED DESCRIPTION OF THE PREFERRED EMBODIMENTS

Below, embodiments of the present invention will be described in greater detail with reference to the drawings. Apparently, the described embodiments are merely part of, rather than all of, the embodiments of the present invention. It should be noted that the figures are illustrative rather than limiting. The figures are not drawn to scale, do not illustrate every aspect of the described embodiments, and do not limit the scope of the present disclosure.

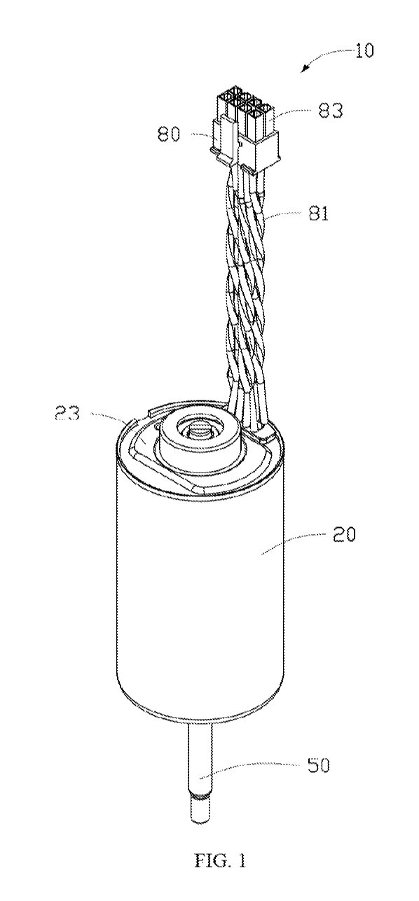

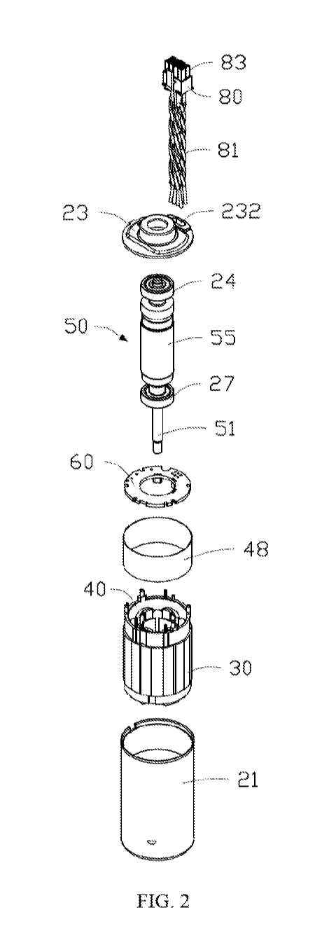

Referring to FIG. 1 and FIG. 2, an electric motor 10 according to an embodiment of the present invention includes a stator 20 and a rotor 50 which is rotatable relative to the stator 20.

The stator 20 includes a cylindrical housing 21 with an open end, an end cap 23 mounted to the open end of the housing 21, a stator core 30 mounted inside the housing 21, an insulating bracket 40 mounted on the stator core 30, a circuit board 60 installed on the insulating bracket 40, an insulated ring 48 surrounding the insulating bracket 40 and the periphery of the circuit board 60, and windings wound on the stator core 30 and supported by the insulating bracket 40. The circuit board 60 is connected to a cable connector 80 which is configured to connect the circuit board 60 to an external power supply and/or a motor control circuit.

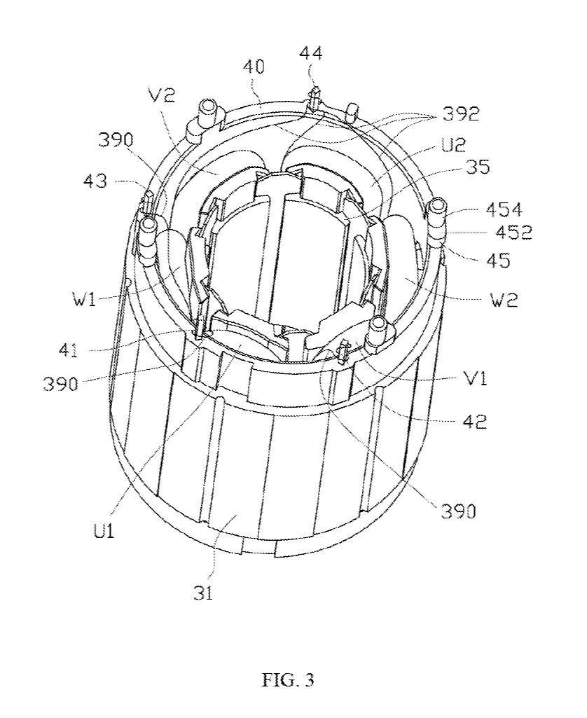

Referring to FIG. 3, the stator core 30 includes an outer yoke 31, a plurality of pole bodies projecting inward from the outer yoke 31, and a pole shoe 35 projecting from the radial inner end of each of the pole bodies toward the two circumferential sides. In this embodiment, the outer yoke 31 has a continuous annular shape and is called as the outer annular portion of the stator 20. The pole shoes 35 cooperatively form a discontinuous annular shape which is called as the inner annular portion of the stator 20. The windings are wound on the corresponding pole bodies and are separated from the stator core 30 by the insulating bracket 40. The stator core 30 is made of magnetic conductive material, for example magnetic conductive laminations (silicon steel sheets commonly used in the art) stacked along the axis of the motor.

Referring back to FIGS. 1 and 2, the rotor 50 is accommodated in a space surrounded by the pole shoes 35 of the pole bodies, and an air gap is defined between the inner end surfaces of the pole shoes 35 and the rotor 50. The rotor 50 includes an annular permanent magnet 55 disposed along a circumferential direction of the rotor 50, and the outer circumferential surface of the annular permanent magnet 55 is concentric with the inner end surfaces of the pole shoes 35. The annular permanent magnet 55 may be formed by an integral ring-shaped permanent magnet. In addition, the rotor 50 further includes a shaft 51 extending through the annular permanent magnet 55. One end of the shaft 51 is mounted to the end cap 23 of the stator 20 via a bearing 24, and the other end of the shaft 51 is mounted to the bottom of the cylindrical housing 21 of the stator 20 via another bearing 27, so that the rotor 50 can rotate relative to the stator 20.

Referring to FIG. 3, in this embodiment, the motor is a three-phase BLDC motor and the stator is a stator with 3-phase and 6-pole. The three phase windings of the stator include U phase winding, V phase winding and W phase winding which are connected in Star configuration. Each phase winding includes two coils, i.e., the U phase winding includes coils U1 and U2, and the V phase winding includes coils V1 and V2, and the W phase winding includes coils W1 and W2. The two coils of each phase winding are respectively wound on the pole bodies which are opposite to each other in the radial direction of the stator. The two coils of each phase winding are wound in the same way, i.e., both are wound clockwisely or counterclockwisely. Each phase winding includes two ends, i.e., a phase connecting end 390 and a neutral point connecting end 392. The two ends of each phase winding are respectively drawn from free ends of the corresponding coils toward the end cap 23.

The insulating bracket 40 is provided with four terminals, which are respectively U phase terminal 41, V phase terminal 42, W phase terminal 43, and neutral point terminal 44. The four terminals project from the insulating bracket 40 toward the end cap 23 and are spaced from each other in the circumferential direction of the insulating bracket 40. The terminals may be posts made of conductive metal materials such as copper. The posts may be cylindrical-shaped, rectangular-shapes etc. Preferably, the terminals are fixed with the insulating bracket 40 via an injection molding. The neutral point terminal 44 may be made into different shapes, such as an inverted hook and the shape is not limited here. The U phase terminal 41, V phase terminal 42, W phase terminal 43 are respectively adjacent the phase connecting ends 390 of the corresponding phase windings, to minimize the length of the phase connecting ends 390 and the degree of clutter of the windings. Specifically, after the coils of the U phase winding are wound around the corresponding pole bodies, the phase connecting end 390 extending from the coil U1 is wound around the U phase terminal 41 with several turns to thereby electrically connect to the U phase terminal 41, and the neutral point connecting end 392 extending from the coil U2 is wound around the neutral point terminal 44 with several turns to thereby electrically connect to the neutral point terminal 44. After the coils of the V phase winding are wound around the corresponding pole bodies, the phase connecting end 390 extending from the coil V1 is wound around the V phase terminal 42 with several turns to thereby electrically connect to the V phase terminal 42, and the neutral point connecting end 392 extending from the coil V2 is wound around the neutral point terminal 44 with several turns to thereby electrically connect to the neutral point terminal 44. After the coils of the W phase winding are wound around the corresponding pole bodies, the phase connecting end 390 extending from the coil W1 is wound around the W phase terminal 43 with several turns to thereby electrically connect to the W phase terminal 43, and the neutral point connecting end 392 extending from the coil W2 is wound around the neutral point terminal 44 with several turns to thereby electrically connect to the neutral point terminal 44. Since the neutral point terminal 44 is electrically conductive, the neutral point connecting ends 392 of the three phase windings realize the electrical connection/combination at the neutral point terminal 44. In other embodiments, in order to make the electrical connection more stable, the phase connecting ends 390 and the corresponding terminals may be welded or soldered together and the neutral point connecting ends 392 and the neutral point terminal 44 may be welded or soldered together.

The side of the insulating bracket 40 toward the end cap 23 is formed with a plurality of mounting portions 45. Each mounting portion 45 includes a supporting seat 452 and a positioning column 454 extending up from a middle of a top of the supporting seat 452.

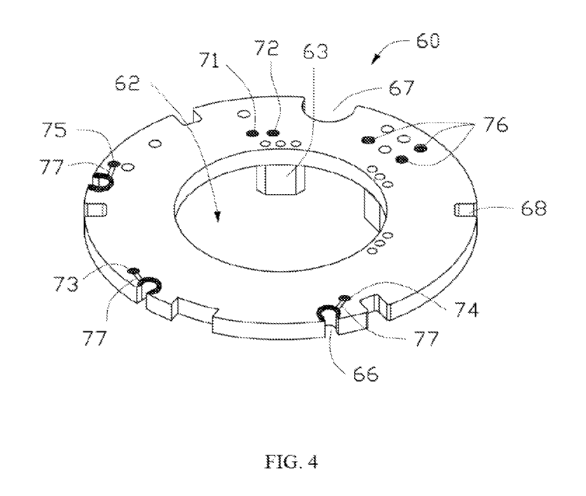

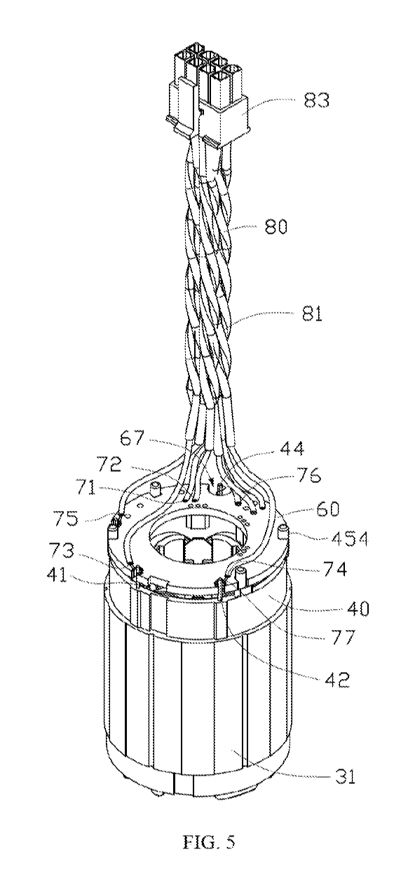

FIG. 4 is an enlarged view of the circuit board 60. FIG. 5 is a perspecitve view of the electric motor with the housing 21, the end cap 23, the insulating ring 48 and the rotor 50 removed. Referring to FIG. 4 and FIG. 5, the circuit board 60 has a general annular shape, and has an opening 62 at the center for passing through of the shaft 51 of the motor. In the embodiment, the circuit board 60 is a hall sensor circuit board which is provided with hall sensors 63 for sensing position of the rotor of the motor. Preferably, the number of the hall sensors 63 is three. The three hall sensors 63 are arranged on a side of the circuit board 60 facing away from the end cap 23 along the circumferential direction of the rotor with an interval of 60 degrees or 120 degrees electric angle. The circuit board 60 defines through holes respectively corresponding to the positioning columns 454, U phase terminal 41, V phase terminal 42, W phase terminal 43 and neutral point terminal 44 of the insulating bracket 40. As shown in FIG. 4, the through holes corresponding to the U phase terminal 41, V phase terminal 42, W phase terminal 43 are denoted as 66, the through hole corresponding to the neutral point terminal 44 is denoted as 67, and the through holes corresponding to the positioning columns 454 are denoted as 68. The size of the through holes 68 corresponds to the size of the positioning columns 454 so that the positioning columns 454 can be firmly fixed in the corresponding through holes 68 to thereby secure the circuit board 60 to the stator 20.

When the circuit board 60 is mounted on the stator 20, the side of the circuit board 60 facing away from the end cap 23 abuts against the supporting seats 452. The size of the through holes 66 corresponding to the U phase terminal 41, V phase terminal 42, W phase terminal 43 is equal to or slightly greater than the size of the corresponding terminals 41, 42, 43. The U phase terminal 41, V phase terminal 42, and W phase terminal 43 extending through the circuit board 60 are welded with the circuit board 60. Preferably, the through holes 66 corresponding to the U phase terminal 41, V phase terminal 42, W phase terminal 43 are pad holes which are used as connecting terminals of the corresponding phase connecting ends 390 of the three phase windings in the circuit board. The circuit board 60 may be stably fixed to the stator 20 by welding. The size of the through hole 67 corresponding to the neutral point terminal 44 is larger than the size of each of the through holes 66, and greater than that of the neutral point terminal 44. The neutral point terminal 44, and the three neutral point connecting ends 392 of the U, V, W three phase windings mounted on the neutral point terminal 44 are spaced from the side wall of the circuit board 60 bounding the through hole 67. That is, the neutral points of the three phase windings and the circuit board 60 are physically spaced to define a clearance, so as to realize the electrical isolation of the neutral points of the three phase windings and the circuit board 60. In this embodiment, the through holes 66, 67, 68 are disposed along the circumferential edge of the circuit board 60, forming notches/cutouts at the edge of the circuit board 60. In other embodiments, the through holes 66, 67 and 68 may have round, square or other suitable shapes and are formed in areas of the circuit board 60 away from the edge of the circuit board 60. Thus, the cross sections of the through holes 66, 67, 68 are closed without opening. The through hole 67 may be free of pad and the area of the through hole 67 is greater than the area of each of the through holes 66.

The side of the circuit board 60 toward the end cap 23 is provided with a plurality of pads, including a positive electrode pad 71, a negative electrode pad 72, U phase winding pad 73, V phase winding pad 74, W phase winding pad 75 and three hall signal pads 76. Each hall sensor 63 includes three pins, i.e., a positive power pin, a negative power pin, and a signal pin. On the circuit board 60, the three positive power pins of the three hall sensors 63 are electrically connected to the positive electrode pad 71 through conductors/wirings on the circuit board, the three negative power pins of the three hall sensors 63 are electrically connected to the negative electrode pad 72 through conductors/wirings on the circuit board, the three signal pins of the hall sensor 63 are respectively electrically connected to the hall signal pads 76 through conductors/wirings on the circuit board 60. The U phase winding pad 73, V phase winding pad 74 and W phase winding pad 75 are respectively adjacent to the corresponding through holes 66, and are electrically connected to the corresponding through holes 66 through the circuit board wirings 77 respectively.

The cable connector 80 includes a plurality of cables 81 and an electric connector 83. One end of each of the cables 81 is connected with a corresponding pad of the circuit board 60, such as electrically connected by welding. The other ends of the cables 81 are electrically connected to an external power supply or a motor control circuit through the electric connector 83. The positive electrode pad 71 and the negative electrode pad 72 are respectively connected to positive electrode and negative electrode of a DC power supply through two of the cables 81 so as to supply a DC power to the hall sensors 63 through the wirings on the circuit board 60. The hall signal pads 76 are connected to the signal output pins of the hall sensors 63 through the wirings on the circuit board 60, and transmit hall signals to the external control circuit through the cables 81. The U phase winding pad 73, V phase winding pad 74 and W phase winding pad 75 are respectively electrically connected to the U phase terminal 41, V phase terminal 42, and W phase terminal 43 weld to the circuit board 60 through the wirings on the circuit board 60. The U phase winding pad 73, V phase winding pad 74 and W phase winding pad 75 are connected to an output end of an inverter of the external control circuit of the motor through the cables 81 so as to control the current flowing through the stator winding in response to the output of the inverter to thereby drive the motor to rotate.

The end cap 23 is mounted to the axial open end of the cylindrical housing 21. The end cap 23 defines a wire outlet 232 for extending through of the cables 81 of the cable connector 80 and leading the cables 81 to outside of the housing 21 to connect to the corresponding external power supply or the control circuit of the motor.

In the embodiment of the invention, the stator 20 of the motor is provided with the neutral point terminal where the neutral point connecting ends of the three phase windings are electrically connected together. Thus, there is no need to connect the neutral point connecting ends through the circuit board, and the circuit board does not need to provide extra space or wiring layer to achieve the combination/electrical connection between the neutral point connecting ends of the three phase windings, which reduces the cost of the circuit board, simplifies the production process of the circuit board. There is an electrical gap between the neutral point connecting ends of the windings and the circuit board, which realizes the effective electrical isolation between the neutral point connecting ends of the windings and the circuit inside the circuit board, and reduces the generation of noise. Moreover, the neutral point connecting ends of the three phase windings only need to be wrapped and/or welded at the neutral point terminal. The operation is simple and convenient.

A person skilled in the art may make various changes according to the technical solution of the present disclosure. For example, the circuit board is not limited to a Hall circuit board, in other embodiments, the circuit board may further provide an inverter, a control unit for controlling commutation of the winding, and a protect unit for protecting the motor from over-current, over-voltage and/or blocking. Thus, there is no need of cables to transmit the hall signals from the circuit board to the control circuit of the motor, and no need of cables to connect the inverter and the phase connecting ends of the windings. The number of the cables can be further reduced. The circuit board is not limited to be mounted to the insulating bracket of the stator. The circuit board may also be installed at other positions of the stator, such as the end cap 23. The connection between the phase connecting ends and the circuit board may be achieved by the phase connecting ends being directly welded on the pads of the circuit board. The shape of the circuit board is not limited to ring-shaped, and can also be other shapes such as sector-shaped, square-shaped or circle-shaped.

Therefore, the technical solutions of embodiments of the present invention have been clearly and completely described above. Apparently, the described embodiments are merely part of, rather than all of, the embodiments of the present invention. A person skilled in the art may make various combinations of technical features in the various embodiments to meet practical needs. Based on the described embodiments of the present invention, any other embodiment obtained by a person skilled in the art without paying creative efforts shall also fall within the scope of the present invention.

1. A stator, comprising a stator core and three phase windings wound on the stator core, the stator further comprising a neutral point terminal, each of the three phase windings comprising a phase connecting end and a neutral point connecting end, the neutral point connecting end of each of the three phase windings being fixed to the neutral point terminal.

2. The stator of claim 1, further comprising a circuit board, wherein the neutral point terminal and the neutral point connecting ends are spaced from the circuit board to define an electrical gap.

3. The stator of claim 2, wherein the circuit board defines a through hole, the neutral point terminal and the neutral point connecting ends fixed to the neutral point terminal extend through the through hole and are spaced from a side wall of the circuit board bounding the through hole.

4. The stator of claim 3, wherein the through hole has no pad.

5. The stator of claim 3, further comprising three phase terminals, wherein the phase connecting ends of the three phase windings are respectively connected to the phase terminals, the circuit board comprises three pad holes corresponding to the three phase terminals, and the three phase terminals are respectively welded to the pad holes.

6. The stator of claim 5, wherein an area of the through hole is greater than that of the pad hole.

7. The stator of claim 5, wherein the circuit board provides a pad corresponding to each pad hole, the pad being electrically connected to the corresponding pad hole via a wiring on the circuit board.

8. The stator of claim 2, wherein the neutral point terminal is a post made of electrically conductive material.

9. The stator of claim 8, wherein each neutral point connecting end is wound around the post with several turns.

10. The stator of claim 8, wherein each neutral point connecting end is fixed to the post via welding or soldering.

11. The stator of claim 1, further comprising an insulating bracket mounted on the stator core, wherein the neutral point terminal is arranged on the insulating bracket.

12. The stator of claim 1, further comprising a housing with an open end and an end cap mounted to the open end, wherein the stator core is mounted in the housing with the neutral point terminal facing the end cap, a wire outlet is defined in the end cap.

13. An electric motor comprising a stator and a rotor rotatable relative to the stator, the stator comprising a stator core and three phase windings wound on the stator core, the stator further comprising a neutral point terminal, each of the three phase windings comprising a phase connecting end and a neutral point connecting end, the neutral point connecting end of each of the three phase windings being fixed to the neutral point terminal.
